(19) United States
(12) Patent Application Publication
(10) Pub. No.: US 2008/0260582 A1
(43) Pub. Date: Oct. 23, 2008

(54) Method for Displacing Small Amounts of Fluids in Micro Channels by Means of Acoustical Waves

(76) Inventors: Christoph Gauer, Munchen (DE); Zeno von Guttenberg, Munchen (DE)

Correspondence Address: DILWORTH & BARRESE, LLP, 333 EARLE OVINGTON BLVD., SUITE 702, UNIONDALE, NY, 11553, US

(21) Appl. No.: 11/665,877

(22) PCT Filed: Oct. 20, 2005
(86) PCT No.: PCT/EP2005/011320

§ 371 Date: Jun. 18, 2008

(30) Foreign Application Priority Data
Oct. 21, 2004 (DE) 10 2004 051 394.5

(51) Int. Cl. B01J 19/00; F17D 1/16; G10K 15/04

(52) U.S. Cl. 422/68.1; 137/13; 181/142

(57) ABSTRACT

A method is provided for displacing small amounts of fluids in micro channels, in which an amount of fluid is introduced into a channel system which has at least one area which corresponds in a topological manner to a ring, such that a closed path of the fluid is possible, and acoustic waves, which have at least one asymmetrical component on the plane of the channel system, are radiated into the fluid, this component defining the direction of displacement of the fluid. A micro channel system for carrying out the method is also provided.

The invention relates to a method for displacing small amounts of fluid in micro channels and a micro channel system to carry out the method.

Miniaturised fluidic systems often consist of closed channels which can be produced from plastics, semiconductor materials or from glass. Such closed channels are described for example in M. G. Pollack and R. B. Fair, Applied Physics Letters, 2000, 77, 1725-1728.

Production methods are, for example wet etching or else hot embossing of plastics for the production of the channels in the substrates. The substrates which are structured in this way are then closed by a cover. Typical channel dimensions are a diameter in the range between 50 μm and a few mm, and a length of the overall system of a few cm. For lab-on-the-chip applications, for example biochemical reactions are to be carried out in these channels. To do this, generally dosaging arrangements, mixers, reaction chambers and branches would have to be realized in such a system. Pump-like systems are necessary for the displacement of the fluid.

Various technologies are available today as pumps for such “lab chips”: peristaltic pumps (U.S. Pat. No. 6,408,878), electrokinetic pumps (U.S. Pat. No. 6,394,759) or else pumps using centrifugal force (“lab-CD”, U.S. Pat. No. 5,472,603).

However, electrokinetic pumps require voltages of several 100 Volts for example and are therefore not very suitable for portable apparatus. In the so-called lab-CDs, the fluids can only be displaced in one direction, i.e. outwards. Miniaturised peristaltic pumps are very complex and therefore expensive.

Other applications use the capillary force in order to displace fluids through channels. Without an additional force, a movement can only take place here in one direction. For example, a hydrophilic channel can indeed be filled with a solution, but when the channel is filled, no further displacement or streaming is possible, which would be provided by the capillary force.

A coupling-in of sound waves into thin, laterally extended fluid films is described in DE 103 25 313 B3. There, ultrasonic frequencies are used, in order to bring about a thorough mixing in a small amount of fluid in a laterally unstructured capillary gap. The irradiation into the fluid film takes place symmetrically in a bilateral manner in the arrangement of DE 103 25 313 B3.

The generating of streaming in fluid by means of sound waves is described in Wesley Le Mars Nyborg “Acoustic Streaming” in Physical Acoustics 2B; Editor W. P. Mason; Academic Press 265 (1965).

It is an object of the present invention to indicate a method and a system by which small amounts of fluids can be displaced in micro channel systems in a manner which is easily controllable and programmable. The method is to be simple to carry out and the materials required for this are to be small, robust and light, so that the method can also be carried out with portable chip labs.

This problem is solved by a method with the features of Claim 1 or a micro channel system with the features of Claim 12. Preferred developments are the subject of sub-claims.

In the method according to the invention, an amount of fluid is introduced into a channel system which comprises at least one area which corresponds in a topological manner to a ring, so that a closed path of the fluid is possible. To generate the displacement, acoustic waves which comprise at least one asymmetrical component in the plane of the channel system are radiated into the fluid, said component defining the direction of displacement of the fluid. Through the impulse transfer of the sound waves onto the fluid, a streaming is generated in the fluid (“acoustic streaming”). By the displacement of the fluid in a closed path, only low outputs are necessary, because no high hydrostatic pressure has to be built up on the closed path in order to generate a displacement. Through the asymmetric component, a direction of displacement is imposed on the fluid, which allows it to move along the closed path.

The channel system may have different geometries, as long as a topologically ring-shaped area is included, which serves for the directed displacement of the fluid on a closed path. The use of a simple ring without branches is particularly simple.

In a simple development, the channel system is upwardly open, e.g. as a groove in a substrate. Through the introduction of displacement on the basis of “acoustic streaming”, an upward closure is not necessary. The streaming-induced displacement can also take place in an open channel.

A channel system which is closed on all sides is more insensitive to external influences. The filling of such a channel system takes place either before a cover is applied onto the groove-shaped channel system, or through a corresponding filling opening, to which for example a pipette can be applied. At another location in the channel system, a ventilation opening is provided, so that the air which is displaced by the introduced fluid can escape. As the movement in the channel system is introduced by the sound-induced streaming, a tight closure is not necessary, as is the case in other methods of the prior art, which use hydrostatic pressure for the displacement.

In a simple manner, the channel system is provided in a substrate. The use of a material which is penetrated by acoustic waves, for example glass, non-elastic plastic or semiconductor materials is advantageous. In this way, in the case of externally arranged sound generators, it is ensured that the displacement is provided by the “acoustic streaming”, generated by the sound waves, and is not provided by a sound wave-induced displacement of the substrate material itself.

The sound waves can be generated by various devices, e.g. with piezoelectric volume oscillators which are applied externally on the system. The use of interdigital transducers, such as are known from high frequency filter technology, is particularly simple and advantageous. Such interdigital transducers, which are applied on piezoelectric materials, can be used by applying a frequency of from 1 to a few 100 MHz to stimulate acoustic waves, particularly surface sound waves, in the piezoelectric material. The sound waves which are thus generated can be coupled into the system, as is also described in DE 103 25 313 B3 for the case of capillary gaps in film form.

In an advantageous development of the method, the interdigital transducer is brought directly in contact with the fluid and is therefore part of the micro channel system. Thus, the sound wave which is generated by the interdigital transducer, is transferred directly into the fluid.

A further advantageous development makes provision that the groove-like channel system is covered by a film, preferably of plastic, against which the interdigital transducer is directly pressed, in order to make possible a direct transfer of the sound waves into the fluid.

The piezoelectric material, generally a chip, can also be used directly as a closure of the channel system and can, in this respect, constitute a part of the channel system.

In order to make displacement possible in the different directions in a channel system, or to allow fluid to flow through branches, several sound wave inducing arrangements can be provided at different locations of the channel system.

A micro channel system according to the invention for displacing small amounts of fluids has at least one channel which constitutes a closed path. A sound-generating arrangement is arranged such that a sound wave, directed into the channel, can be coupled in.

The method according to the invention is to be used advantageously in particular when individual areas of the micro channel system are functionalized biologically, chemically, physically or in another way. The fluid can be guided past such a functionalized site by means of the method according to the invention in a micro channel system according to the invention, so that all the fluid reliably comes in contact with the functionalization. In other applications, the fluid can be guided past correspondingly arranged measurement points. With a corresponding configuration of the micro channel system with branches, a dosaging or division of individual amounts of fluid is possible, which can be subjected to different treatments in the individual branches.

The invention is explained in detail with the aid of the enclosed figures, which show diagrammatic views of the system according to the invention in the carrying out of the method according to the invention, in which:

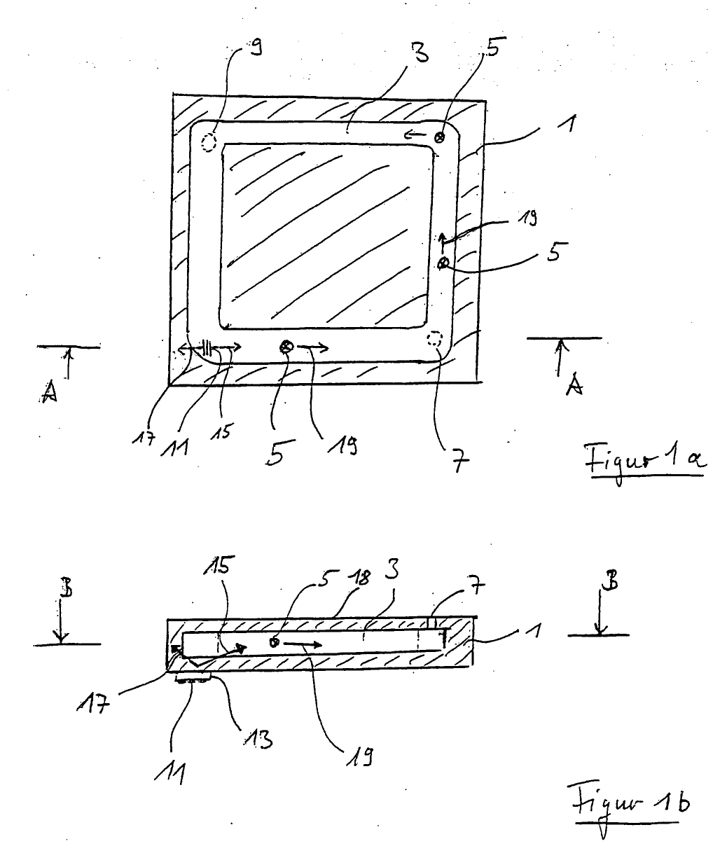

FIG. 1a shows a schematized longitudinal sectional view of a system according to the invention,

FIG. 1b shows a cross-sectional view of the system of FIG. 1a,

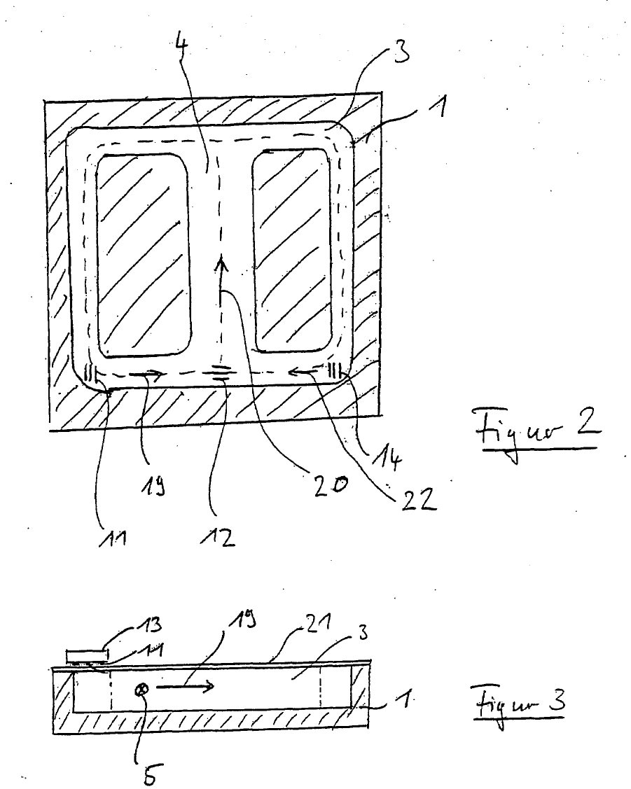

FIG. 2 shows a schematized longitudinal section of another embodiment according to the invention,

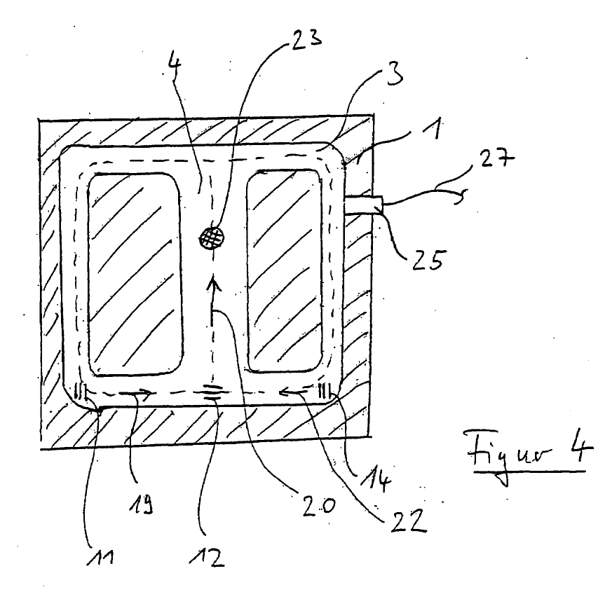

FIG. 3 shows a cross-section of a further embodiment according to the invention, and

FIG. 4 shows a diagrammatic longitudinal section through a further embodiment according to the invention.

FIG. 1a shows a longitudinal section through a micro channel system. The micro channel 3 can be seen, which for example has a diameter in the range from 50 μm to a few mm. It is formed for example by wet chemical etching in a substrate 1, which consists for example of glass, semiconductor materials or of a non-elastic plastic. The fluid, which is indicated by way of example by the crosses 5, moves in the channel. The direction of movement is indicated here by 19.

FIG. 1b shows a cross-section in viewing direction A of FIG. 1a. The ring-shaped channel 3 has a filling opening 7 which is visible in this cross-sectional view. Beneath the substrate 1 in the region of a corner, a piezoelectric substrate 13 is arranged, on which an interdigital transducer 11 is situated, which can be controlled in a manner which is known and therefore is not illustrated here by an electric alternating field. If necessary, a coupling medium (e.g. water) can be provided between the piezoelectric material 13 and the substrate 1, in order to avoid an undesired reflection of the sound waves at a thin air gap which may possibly be present. Interdigital transducers which are known per se from surface wave filter technology comprise metallic electrodes which are constructed in the manner of a comb, the doubled finger distance of which defines the wave length of the surface sound wave and which can be produced by optical photolithography methods, e.g. in the region of around 10 μm finger distance. Such interdigital transducers are provided on piezoelectric crystals in order to stimulate surface sound waves thereon in a manner known per se. The application of an electric alternating field of a few to a few 100 MHz in a manner known per se to the finger electrodes of the interdigital transducer 11 which are engaging into each other brings about the generation of surface sound waves which lead to the production of sound waves 15, 17 in a similar manner to that described in DE 103 25 313 B3. The application of the alternating field can take place via corresponding electrical connections or, for example, by wireless irradiation.

The longitudinal sectional view of FIG. 1a corresponds approximately to the viewing direction B which is indicated in FIG. 1b.

The position of the interdigital transducer 11 and the directions of radiation of the sound waves 15, 17 are also indicated in FIG. 1a, although they would not be visible per se in the longitudinal sectional view of FIG. 1a. In FIG. 1a in addition the filling hole 7 and the ventilation hole 9 are indicated, which in fact likewise would not be visible in the longitudinal sectional view of FIG. 1a, because they are provided in the upper closure 18 in the embodiment which is shown.

The arrangement illustrated in FIGS. 1a and 1b can be used as follows. Fluid is introduced into the system through the filling opening 7. The capillary force can be used here, which sucks the fluid through the channel 3. Alternatively, the fluid can be introduced through the filling opening 7 e.g. with an injector or pipette. The air which is displaced out of the channel 3 by the fluid emerges through the ventilation opening 9. Finally, the channel is completely filled with fluid. After filling, the filling opening 7 and the ventilation opening 9 can be closed, which, however, is not necessary. The application of an electric alternating field in the order of 1 MHz to a few 100 MHz on the interdigital transducer 11, which is only illustrated schematically, brings about the generation of a surface sound wave on the piezoelectric substrate 13, which brings about the radiation of sound waves 15, 17 perpendicularly to the finger orientation of the interdigital transducer 11. Whilst the sound wave 17 radiates outwards and therefore remains without a substantial effect on the fluid, the sound wave 15 radiates directly into the channel 3. The sound waves penetrate the substrate material of glass, plastic or semiconductor material and generate a streaming in the fluid: “acoustic streaming”. Fluid particles 5 are accelerated by the sound impulse transmission in direction 19 and bring about a displacement along the channel 3.

As the channel system is already filled before the sound wave is radiated in, only a very low pressure is necessary. In this respect, the electric outputs from the interdigital transducer 11 of less than 1 Watt are sufficient in order to bring about a movement of the fluid.

Through the arrangement of the interdigital transducer 11 in a corner of the channel system 3, it is ensured that only one sound component 15 acts in the direction of the channel 3, whilst the other sound wave, which is generated by the interdigital transducer, is radiated outwards. Alternatively, a unidirectional transducer design can be used, which only radiates in one direction. Such a unidirectional transducer can be used at any desired location on the channel 3. Finally, geometries can be realized in which the counter beam 17 is not radiated outwards, but rather is systematically absorbed or reflected.

The channel system may have different geometries, as long as only one closed path is possible. Another development is shown for example by FIG. 2 with a branch 4. The interdigital transducer 11 is used, as described for FIG. 1, to generate a displacement in direction 19. A further interdigital transducer 12 can bring about a displacement along the branch 4 in direction 20.

The direction of displacement of the fluid can be turned around by means of an interdigital transducer 14, so that the fluid moves in direction 22.

In an embodiment which is not shown, the channel system can be upwardly open.

FIG. 3 shows another embodiment of a micro channel system according to the invention, in cross-section. Here, the channel system 3 is closed off by a plastic film 21, onto which the piezoelectric material 13 is pressed, with the interdigital transducer 11 applied thereon, so that the air gap between the transducer and the film is smaller than the sound wave length (1 to a few 100 μm), in order to avoid reflections at the air gap. The sound wave penetrates the plastic film and the energy transmission to the fluid takes place by acoustic streaming and not by the sound-induced movement of the film itself.

In a further embodiment, which is not illustrated in the figures, the piezoelectric material for the generation of the acoustic waves is used directly as a cover for the channel system.

FIG. 4 shows in diagrammatic representation a micro channel system according to the invention, with a functionalized area 23. This functionalized area may, for example, have a physical, chemical, biological or other functionalization, which is provided for a reaction with the fluid in the channel system 3, 4. After the fluid has been introduced into the channel system for example through a filling opening corresponding to the filling opening 7 of FIG. 1, a streaming is generated either by means of the interdigital transducer 11 or the interdigital transducer 14, as described in channel 3. The application of a further electrical alternating field onto the interdigital transducer 12 brings about a movement in direction 20 through the branch 4. The fluid is thus guided past the functionalized area 23. By the streaming in the channel system 3,4 it can be ensured that all the fluid can come in contact with this functionalized area and, for example, can undergo a reaction.

25 designates only diagrammatically a measurement arrangement which may, for example, be electrical or optical. 27 likewise designates only diagrammatically the electrical connection of this measurement arrangement. If the fluid moves in the channel 3, e.g. through stimulation of streaming by the interdigital transducer 11 or by the interdigital transducer 14, then the fluid is guided past this measurement point 25. The continuous streaming guarantees that all the fluid flows past the measurement point.

The generation of sound waves in the fluid by means of surface sound waves which are generated by an interdigital transducer on a piezoelectric material is particularly advantageous for the method according to the invention, because the sound wave which is produced in this way already has a large component in the direction of the channel.

The method according to the invention and respectively the micro channel system according to the invention have the further advantage that they can not only be used to displace the fluid along the channel, but also for the thorough mixing of the fluid. To do this, the sound wave generating arrangements are operated with such a low output that the energy is not sufficient for the streaming of the entire system. Alternatively, two transducers which have a countercurrent radiation direction, such as e.g. the transducers 11 and 14 of FIG. 2, can be operated simultaneously, so that a streaming of the fluid is not possible and only a thorough mixing takes place.

Of course, the embodiments which are described here only realize examples of possible geometries, without the invention being restricted to the illustrated specific forms of the channel system. Moreover, any desired number of interdigital transducers having different radiation directions can be provided on the channel.

1. A method for displacing small amounts of fluids in micro channels, in which
an amount of fluid is introduced into a channel system (3,4) which comprises at least one area which corresponds in a topological manner to a ring, such that a closed path of the fluid is possible, and
acoustic waves (15) which comprise at least one asymmetrical component in the plane of the channel system (3,4) are radiated into the fluid, said component defining the direction of displacement of the fluid,
wherein
to produce the acoustic waves at least one interdigital transducer (11) on a piezoelectric material (13) is used.

2. The method according to claim 1, in which the channel system comprises a ring (3).

3. The method according to claim 1, in which a channel system is used which is upwardly open.

4. The method according to claim 1, in which a channel system (3,4) is used, which is closed on all sides with the exception of a filling opening (7) and a ventilation opening (9).

5. The method according to claim 1, in which the channel system (3,4) which is used is formed in a substrate (1) of glass, non-elastic plastic or semiconductor material.

6. The method according to claim 1, in which the interdigital transducer is directly in contact with the fluid.

7. The method according to claim 1, in which the channel system (3,4) is covered with a film, preferably a plastic film, against which the interdigital transducer (11) is pressed.

8. The method according to claim 1, in which the channel system is closed off at one place by the piezoelectric material, on which the interdigital transducer is applied.

9. The method according to claim 1, in which the frequency of the sound waves is selected in the range between one MHz and several 100 MHz.

10. The method according to claim 1, in which several sound-generating arrangements (11,12,14) are used, in order to bring about different movements.

11. A micro channel system to carry out a method according to claim 1 for the displacement of small amounts of fluids, having
at least one channel (3) which represents a closed path, and
at least one sound-generating arrangement (11,14) which is arranged and/or shaped such that a sound wave (15) can be radiated in a directed manner into the channel (3), in which the at least one sound-generating arrangement comprises an interdigital transducer (11,14).

12. The micro channel system according to claim 11, in which the channel system (3,4) is closed on all sides with the exception of a filling opening (7) and a ventilation opening (9).

13. The micro channel system according claim 11, in which the channel system is constructed as a groove in a substrate (1), which is closed off by a cover (21).

14. The micro channel system according to claim 13, in which the cover (21) is composed of film, preferably plastic film, and the sound-generating arrangement (11) lies directly against the cover (21).

15. The micro channel system according to claim 11, in which the channel system is upwardly open.

16. The micro channel system according claim 11, in which the at least one sound-generating arrangement is arranged outside the channel system (3,4).

17. The micro channel system according to any of claim 11, having several sound-generating arrangements (11,12,14) which are arranged such that they are able to radiate sound waves in different directions into the channel system (3,4).

18. The micro channel system according to any of claim 11, in which the channel system (3,4) is formed in a substrate (1) of glass, non-elastic plastic or semiconductor material.

19. The micro channel system according to claim 11, in which at least one biologically, chemically or physically functionalized area (23) is provided inside the channel system (3,4).

20. The micro channel system according to claim 11, in which a measuring arrangement (25) for measuring a physical, biological or chemical parameter is provided in at least one area of the channel system (3,4).

21. A method according to claim 1, in which the fluid (5) is moved past at least one biologically, chemically or physically functionalized area (23) inside the channel system (3,4).

22. The method according to claim 1, in which the fluid (5) is moved past at least one measurement point (25) to measure a physical, biological or chemical parameter.
